(19) United States
(12) Patent Application Publication
(10) Pub. No.: US 2026/0302369 A1
(43) Pub. Date: Oct. 1, 2026

(54) SECONDARY BATTERY

(71) Applicant: SAMSUNG SDI CO., LTD., Yongin-si (KR)

(72) Inventor: JEON KI YOUN, Yongin-si (KR)

(21) Appl. No.: 19/309,961

(22) Filed: Aug. 26, 2025

(30) Foreign Application Priority Data
Mar. 31, 2025 (KR) 10-2025-0041002

(51) Int. Cl. H01M 10/0587; H01M 10/052; H01M 50/105; H01M 50/463; H01M 50/538

(52) U.S. Cl. CPC H01M 10/0587; H01M 10/052; H01M 50/105; H01M 50/463; H01M 50/538; H01M 2220/20

(57) ABSTRACT

Embodiments relate to a secondary battery. The secondary battery includes a first electrode plate on which a notching pattern is disposed for each turn of winding, a second electrode plate which is wound together with the first electrode plate and on which a notching pattern is disposed for each turn, and a separator disposed between the first electrode plate and the second electrode plate and configured to electrically insulate the first electrode plate and the second electrode plate from each other. Each of the first electrode plate and the second electrode plate is folded and wound along a folding line for each turn.

### CROSS-REFERENCE TO THE RELATED APPLICATION

The present application claims priority to and the benefit of Korean Patent Application No. 10-2025-0041002, filed on Mar. 31, 2025, in the Korean Intellectual Property Office, the entire disclosure of which is incorporated herein by reference.

### BACKGROUND

### 1. Field of the Disclosure

The present disclosure relates to a secondary battery.

### 2. Description of Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the invention and therefore it may contain information that does not constitute prior art.

### SUMMARY

Aspects of some embodiments of the present disclosure provide a secondary battery to which a winding-type two-dimensional cell is applied and in which a pattern is designed before winding. Additionally, notching is performed in advance to implement the winding-type two-dimensional cell.

However, the technical problems to be achieved in the embodiment of the disclosure are not limited to the technical problems mentioned above, and other technical problems not mentioned herein will be clearly understood from the following description by those skilled in the art to which the disclosure belongs.

According to some embodiments, a secondary battery includes: a first electrode plate on which a notching pattern is disposed for each turn of winding; a second electrode plate which is wound together with the first electrode plate and on which a notching pattern is disposed for each turn; and a separator disposed between the first electrode plate and the second electrode plate and configured to electrically insulate the first electrode plate and the second electrode plate from each other, wherein each of the first electrode plate and the second electrode plate is folded and wound along a folding line for each turn.

In some embodiments, a first electrode tab may be connected to one end of the first electrode plate in a longitudinal direction.

In some embodiments, a second electrode tab may be connected to one end of the second electrode plate in a longitudinal direction.

In some embodiments, the first electrode plate may be a positive electrode plate, and the second electrode plate may be a negative electrode plate.

In some embodiments, the separator may be provided in a rectangular shape. After being wound together with the first electrode plate and the second electrode plate, only a portion may be cut, the portion corresponding to the notching pattern disposed on each of the first electrode plate and the second electrode plate.

In some embodiments, the separator may be disposed across the entire first electrode plate and second electrode plate in the width direction.

In some embodiments, a width of the separator may be larger than a width of each of the first electrode plate and the second electrode plate, respectively.

In some embodiments, the notching pattern disposed on the first electrode plate may be a first pattern, wherein the first pattern may be continuously disposed along a longitudinal direction of the first electrode plate.

In some embodiments, the first pattern may include a square groove.

In some embodiments, the notching pattern disposed on the second electrode plate may be a second pattern, wherein the second pattern may be continuously disposed along a longitudinal direction of the second electrode plate.

In some embodiments, the second pattern may include a square groove.

In some embodiments, in a state where the first electrode plate and the second electrode plate overlap each other with the separator therebetween, while a groove of the first pattern and a groove of the second pattern correspond to each other, the first electrode plate and the second electrode plate may be folded and wound.

In some embodiments, for each turn of the winding, the notching patterns of the first electrode plate and the second electrode plate may be different from each other. Also, pattern sizes may gradually decrease as each of the notching patterns traverses a length towards an inside of the wound first and second electrode plates.

In some embodiments, the folding line may be defined as a folding reference point along a longitudinal direction of each of the first electrode plate and the second electrode plate and may be configured to induce a folding action during the winding process of the first electrode plate and the second electrode plate.

In some embodiments, the folding line may include: a first line disposed at a center of the notching pattern; and a second line disposed in the middle between the first line and the adjacent first line.

In some embodiments, a length of the notching pattern in the width direction may be defined as 2xₙ=2(xₙ₊₁+f(aₙ₊₁)) where 2xₙ is a length of the notching pattern at an n-th turn in the width direction, 2xₙ₊₁ is a length of the notching pattern at an (n+1)-th turn in the width direction, and f(aₙ₊₁) represents a correction value calculated by considering the first electrode plate, the second electrode plate, the separator, and a spaced gap at the (n+1)-th turn.

In some embodiments, the correction value f(aₙ) may be calculated as f(aₙ)=π(Rₙ₋₁−Rₙ)/2, where Rₙ is a winding radius defined with respect to a center of curvature disposed at a center of the notching pattern at the n-th turn, and Rₙ₋₁ is a winding radius defined with respect to a center of curvature disposed at a center of the notching pattern at the (n−1)-th turn.

According to some embodiments, a secondary battery includes: a case, an electrode assembly accommodated in the case, with the electrode assembly including a first electrode plate on which a notching pattern is disposed for each turn of winding; a first electrode tab disposed at one side of an end of the first electrode plate in a longitudinal direction; a second electrode plate which is wound together with the first electrode plate and on which a notching pattern is disposed for each turn; a second electrode tab disposed at one side of an end of the second electrode plate in a longitudinal direction; a separator disposed between the first electrode plate and the second electrode plate and configured to electrically insulate the first electrode plate and the second electrode plate from each other; the first electrode plate, the second electrode plate, and the separator being wound, wherein each of the first electrode plate and the second electrode plate is folded and wound along a folding line for each turn.

In some embodiments, the notching pattern disposed on the first electrode plate may be a first pattern, wherein the first pattern may be continuously disposed along a longitudinal direction of the first electrode plate.

In some embodiments, the notching pattern disposed on the second electrode plate may be a second pattern, wherein the second pattern may be continuously disposed along a longitudinal direction of the second electrode plate.

In some embodiments, each of the first pattern and the second pattern may include a square groove.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 illustrates an exploded perspective view of a secondary battery according to embodiments;

FIG. 2 illustrates a perspective view of the secondary battery according to embodiments;

FIG. 3 illustrates a plan view of the secondary battery according to embodiments;

FIG. 4 illustrates an exploded plan view of an electrode assembly according to embodiments;

FIG. 5 illustrates a plan view of a positive electrode according to embodiments;

FIG. 6 illustrates a cross-sectional view of one bent side of the electrode assembly according to embodiments;

FIG. 7 illustrates a cross-sectional view of a curvature and radius of the electrode assembly according to embodiments;

FIG. 8 illustrates a plan view of a secondary battery according to other embodiments;

FIG. 9 illustrates an exploded plan view of an electrode assembly according to other embodiments;

FIGS. 10 and 11 illustrate perspective views of a battery pack including an exemplary secondary battery according to embodiments; and

FIGS. 12 and 13 illustrate perspective and side views of a vehicle including an exemplary battery pack according to embodiments.

### DETAILED DESCRIPTION

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

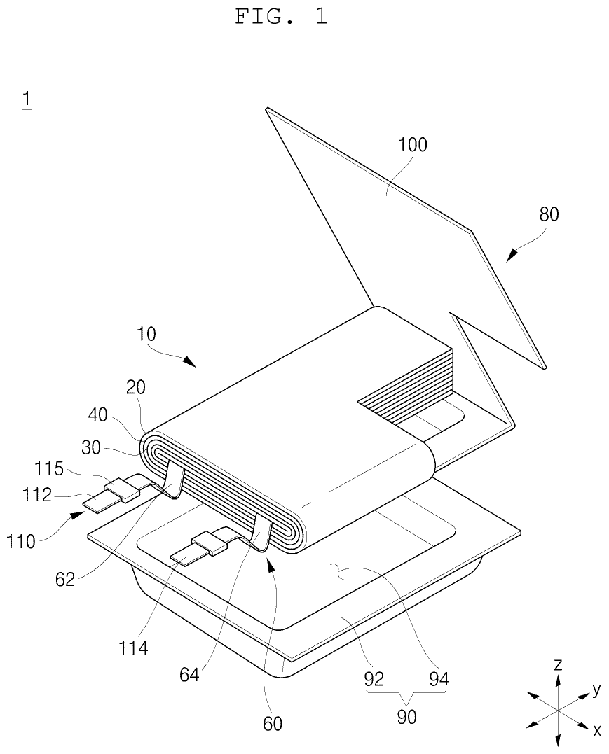

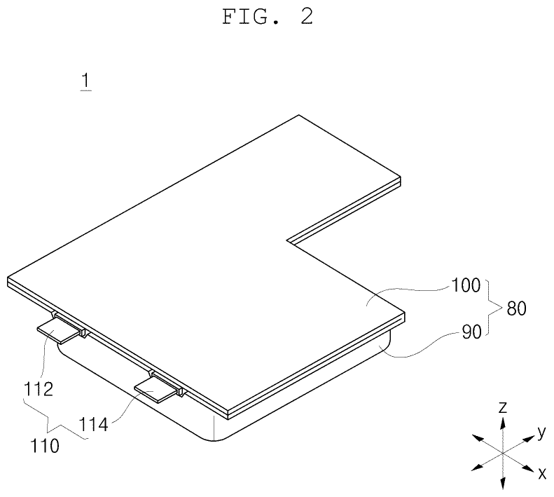

FIG. 1 illustrates an exploded perspective view of a secondary battery 1 according to embodiments, and FIG. 2 illustrates a perspective view of the secondary battery 1 according to embodiments. As illustrated in FIGS. 1 and 2, the secondary battery 1 may include an electrode assembly 10 including a first electrode plate 20, a second electrode plate 30, and a separator 40. The secondary battery 1 according to embodiments may further include an electrode tab 60, a case 80, an electrode lead 110, and an insulating tape 115.

Directions are defined. A longitudinal direction may be defined as longitudinal direction y, a width direction that intersects perpendicularly with the longitudinal direction y may be defined as width direction x, and a vertical direction that intersects perpendicularly with the longitudinal direction y and the width direction x may be defined as vertical direction z. The longitudinal direction y may be referred to as a first direction, the width direction x may be referred to as a second direction, and the vertical direction z may be referred to as a third direction.

The present disclosure may relate to the secondary battery 1 and may provide a winding-type two-dimensional cell including the electrode assembly 10. The secondary battery 1 may include a first electrode plate 20 and a second electrode plate 30, in which a predefined notching pattern is disposed for each turn of the winding, a separator 40 disposed between the electrode plates to provide electrical insulation, and a case 80 capable of accommodating the electrode assembly 10.

In the electrode assembly 10 according to embodiments, the first electrode plate 20 and the second electrode plate 30 may be folded along a folding line 50 for each turn and thus be maintained in symmetry to improve energy density and maximizing space utilization. In some embodiments, a technology for optimizing an internal structure of the electrode assembly 10 and improving reliability may be provided through the predefined notching pattern and correction of a winding radius and length based on the predefined notching pattern.

The electrode assembly 10 may include an electrode tab 60, an electrode lead 110, an insulating tape 115, etc., and the electrode assembly 10 and an electrolyte may be accommodated together within the case 80. Due to this technology, in the present disclosure, manufacturing efficiency of the winding-type secondary battery 1 may be improved, and reliability and electrical safety of the winding-type secondary battery 1 may be enhanced.

The electrode assembly 10 may include a first electrode plate 20, a second electrode plate 30, and a separator 40. The electrode assembly 10 may be performed by rolling the first electrode plate 20, the second electrode plate 30, and the separator 40 during a winding process. In some embodiments, the electrode assembly 10 may be implemented in various modifications, such as a stack configuration, in which the first electrode plate 20, the second electrode plate 30, and the separator 40 are alternately stacked.

The electrode assembly 10 according to embodiments may be accommodated in the case 80 and provided with the first electrode plate 20, the second electrode plate 30, and the separator 40 disposed between the first electrode plate 20 and the second electrode plate 30. An electrode tab 60 may be disposed at one side of the electrode assembly 10. In the present disclosure, the case 80 may be referred to as a pouch.

The electrode assembly 10 may be accommodated inside the pouch together with the electrolyte. The electrolyte may be provided as a combination of an organic solvent and a lithium salt. The organic solvent may include, but is not limited to, ethylene carbonate (EC), propylene carbonate (PC), diethyl carbonate (DEC), ethyl methyl carbonate (EMC), and dimethyl carbonate (DMC). Lithium hexafluorophosphate (LiPF₆) or lithium tetrafluoroborate (LiBF₄) may be used as lithium salts, and the electrolyte may be provided in consideration of electrical and chemical reactivity with the electrode.

The electrode tab 60 may include a first electrode tab 62 and a second electrode tab 64. The electrode tab 60 may be welded to the electrode lead 110 and electrically connected to the outside. The insulating tape 115 may be attached to the electrode lead 110 for insulation from the pouch.

The case 80 may accommodate the electrode assembly 10 in which the first electrode plate 20, the second electrode plate 30, and the separator 40 are wound. The case 80 may be sealed in a state in which the electrode lead 110 electrically connected to the electrode assembly 10 is withdrawn from the outside of the case 80.

The case 80 may be transformed into various shapes, such that the case may be installed in a shape that surrounds the outside of the electrode assembly 10. In the present disclosure, the case 80 may use a pouch made of a soft film. The pouch may be provided with a case body 90 and a case cover 100 by folding a rectangular film extending in the first direction y.

After the electrode assembly 10 is accommodated in a recess 94 provided in the case body 90, the case cover 100 may rotate to shield an opened entrance of the case body 90. In the present disclosure, the pouch is not limited to the integrated form in which the case body 90 and the case cover 100 are disposed on a single film. However, for convenience of explanation, the following description will be given as an example which the case body 90 and the case cover 100 are disposed on a single rectangular film.

In some embodiments, the case body 90 may include the recess 94 and a sealing part 92. The case body 90 may be provided with the recess 94, in which the electrode assembly 10 is accommodated at approximately the center, and may include the sealing part 92 extending approximately outward from three sides of the recess 94.

The sealing part 92 may be a surface that is parallel to and coupled to the case cover 100. For example, if the case body 90 and the case cover 100 are provided as separate members, the sealing part 92 may extend outward from the four sides of the recess 94. In some embodiments, even if the case body 90 and the case cover 100 are integrated with each other, the sealing part 92 may extend outward from the four sides of the recess 94.

The case cover 100 and the case body 90 may be provided as a multilayer thin film including a metal thin film and insulating layers that are disposed on one side and the other side of the metal thin film, respectively. The case cover 100 and the case body 90 may define surfaces that are in contact with each other as inner surfaces, and opposite surfaces as outer surfaces.

The recess 94 of the case body 90 may be provided to a size that is enough to accommodate the electrode assembly 10 through one of several provisioning means, such as pressing or drawing processing, etc. In the case body 90, an edge of the recess 94 and an edge of the case cover 100 may be thermally fused to each other after the case cover 100 covers the portion in which the recess 94 is defined. The pouch may be sealed by sealing an edge area of the case body 90 and an edge area of the case cover 100 after the electrode assembly 10 is accommodated in the recess 94.

For convenience, the sealing part 92 may be the edge of the case body 90 and may be disposed on the outer side of a plane with respect to the recess 94 that is sealed with the edge of the case cover 100. An inner surface of the pouch may have a thermal fusion layer made of a thermal fusion material.

The case cover 100 may have a rectangular flat shape. The case cover 100 may be connected to the case body 90 to cover an upper portion of the case body 90 using a folding operation.

The case 80 may be changed into various shapes depending on the shape of the electrode assembly 10. For example, if the electrode assembly 10 is provided in an “L” shape, the case 80 may also be designed in an “L” shape to stably accommodate the electrode assembly 10. In some embodiments, the case body 90 and case cover 100, which constitute the case 80, may also be manufactured in matching shapes. For example, the case body 90 and the case cover 100 (or the case 80) may be manufactured in an “L” shape corresponding to the shape of the electrode assembly 10, and the electrode assembly 10 may be protected and sealed more efficiently through this design.

In some embodiments, if a width of the electrode assembly 10 in the width direction x is not constant and has a multi-stage structure, a shape of the pattern provided on the first electrode plate 20 and the second electrode plate 30 may also be optimized in consideration of the shape of the wound electrode assembly 10. For example, the pattern shape may be designed according to a change in curvature, radius, and width direction x of the electrode assembly 10 at each winding stage. This design may maintain uniformity of a gap between respective components of the electrode assembly 10 after the winding to maximize the utilization of the internal space and improve the electrical connection efficiency.

The shape of the case 80 may be designed not only to surround an outer surface of the electrode assembly 10, but also to absorb a mechanical impact that may occur inside the secondary battery 1 or to minimize an interference with the electrode lead 110 and the electrode tab 60. For example, a reinforcing rib or buffer structure may be added inside the case 80 to accommodate the multi-stage electrode assembly 10, and the structural improvement may further improve the durability and electrical reliability of the battery.

The electrode lead 110 may be connected to the electrode assembly 10. One side of the electrode lead 110 may be electrically connected to the electrode tab 60 of the electrode assembly 10, and the other side of the electrode lead 110 may extend to the outside of the case 80. In some embodiments, the electrode lead 110 may include a positive electrode lead 112 connected to the first electrode tab 62 and a negative electrode lead 114 connected to the second electrode tab 64.

The insulating tape 115 may be disposed between the electrode lead 110 and the case 80 and may be deformed into various shapes within the technical concept of being fixed to the outside of the electrode lead 110. The insulating tape 115 may be installed on each of both surfaces of the electrode lead 110 facing the case 80. Because the insulating tape 115 may be installed, the electrical connection between the electrode lead 110 and the case 80 may be blocked.

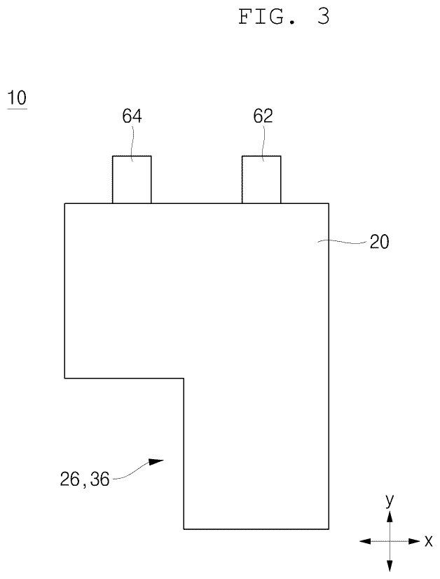

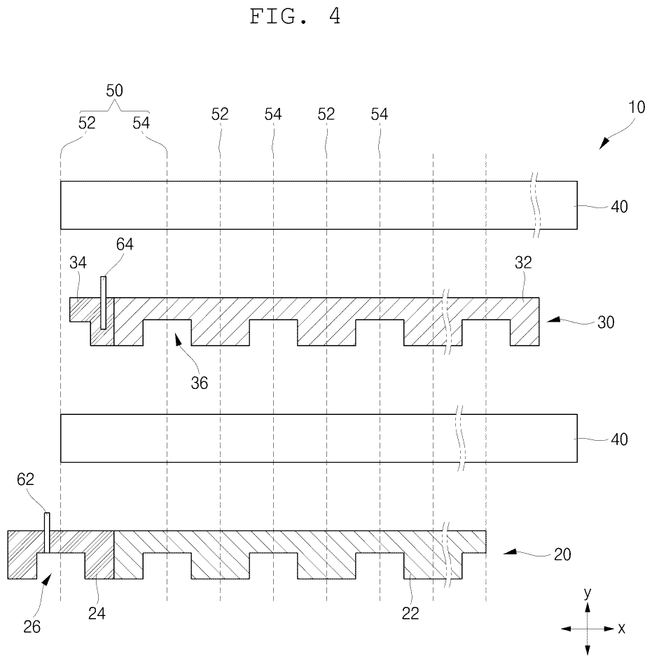

FIG. 3 illustrates a plan view of the secondary battery 1 according to embodiments, and FIG. 4 illustrates an exploded plan view of the electrode assembly 10 according to embodiments. As illustrated in FIGS. 3 and 4, the electrode assembly 10 may include the first electrode plate 20, the second electrode plate 30, and the separator 40, and the number of first electrode plate 20 and the number of second electrode plate 30 may be the same. However, a number of separators greater than that of first electrode plate 20 and second electrode plate 30 may be provided to ensure electrical insulation and structural stability of the electrode assembly 10.

In some embodiments, the electrode assembly 10 may be constituted by one first electrode plate 20, one second electrode plate 30, and two separators 40. This configuration is designed to ensure that there is electrical insulation between the respective electrodes and to prevent short circuit between electrode plates during the winding or stacking process.

In some embodiments, the number of first electrode plate 20, second electrode plate 30, and separator 40, which are components of the electrode assembly 10, may vary depending on a size, capacity, and purpose of the secondary battery 1. For example, in large-scaled batteries, the number of each electrode plates and separators 40 may increase to increase in capacity of the electrode assembly 10, and in batteries used in small electronic devices, the number of each electrode and separator 40 may be minimized to achieve lightweight.

In some embodiments, the separator 40 may also serve to reinforce structural support and thermal stability of the electrode plate. In some embodiments, the separator 40 may include multilayer structure or a special coating layer and thus be designed in a manner to minimize heat shrinkage characteristics or improve electrolyte retention characteristics.

The first electrode plate 20 may be modified in various manners in accordance with the technical concept for forming the predefined notching pattern for each turn of the winding. The first electrode plate 20 may be generally used as the positive electrode plate, and correspondingly, the second electrode plate 30 may be used as the negative electrode plate. The first electrode plate 20 may include a positive electrode coating portion 22 and a positive electrode non-coating portion 24, and a first pattern 26 may be disposed as a notching pattern on the areas.

The first electrode plate 20 may be provided in a square structure extending in the width direction x and may be designed to facilitate a winding and electrical connection of the electrode assembly 10. The positive electrode coating portion 22 and the positive electrode non-coating portion 24 may be configured to minimize an interference between the electrodes and prevent the electrical short-circuit during the winding process.

The first electrode plate 20 may be a plate-shaped structure made of aluminum (Al) and may include a negative electrode coating portion 32 coated with a negative electrode active material made of transition metal oxide on at least one surface of the first electrode plate 20. The positive electrode active material may be lithium transition metal composite oxide. For example, lithium nickel, lithium cobalt, or lithium manganese composite oxide may be used as the positive electrode active material.

The positive electrode coating portion 22 may be an area coated with the positive electrode active material and may be a main portion that generates electricity through an electrochemical reaction. In contrast, the positive electrode non-coating portion 24 may be an area that is not coated with the positive electrode active material and may be mainly used for connection with the electrode tab 60. The positive electrode non-coating portion 24 may be disposed at a position adjacent to the positive electrode coating portion 22 and may be designed to improve the structural stability during the winding process.

The notching pattern disposed on the first electrode plate 20 may be provided as a first pattern 26, which may be disposed continuously at a set interval along the longitudinal direction y of the first electrode plate 20. The first pattern 26 may be provided in the form of a square groove, and the groove may be disposed at a lower side of the first electrode plate 20.

The first pattern 26 may be provided as a notching pattern disposed on the first electrode plate 20 and may be designed to correspond to the shape of the electrode assembly 10 in which the winding is completed.

The first pattern 26 may be generally required if the wound electrode assembly 10 has an asymmetric structure. If the wound electrode assembly 10 has a rectangular shape, the first pattern 26 may be unnecessary. This may be because the rectangular electrode assembly 10 is maintained in symmetrical structure and gap uniformity without a separate pattern.

The first pattern 26 may be generally designed in a square groove shape, but may be modified into a triangular, semicircular, or polygonal shape depending on an outer appearance of the wound electrode assembly 10. The first pattern 26 may be disposed on any one of a lower end, an upper end, or a side surface of the first electrode plate 20.

A gap between a plurality of first patterns 26 may be adjusted in consideration of physical characteristics of the wound electrode assembly 10 such as the radius, length, and width. The first pattern 26 may be necessarily disposed only if the wound electrode assembly 10 has a shape rather than a rectangular shape, i.e., if having a curved, multi-stage, or asymmetrical shape. For example, if the wound electrode assembly 10 is provided in an “L” shape, a “U” shape, or a multi-stage shape, the first pattern 26 may be necessary to correct an internal curvature of the electrode assembly 10 and maintain the structural stability.

The first electrode tab 62 may be electrically connected to the positive electrode non-coating portion 24 of the first electrode plate 20. In some examples, a first electrode tab 62 may be connected to one side (left side in FIG. 4) of an end in the width direction x of the first electrode plate 20. The first electrode plate 20 may have a rectangular shape extending in the width direction x of the electrode assembly 10, and the positive electrode non-coating portion 24 may be disposed at one side (left side in FIG. 4) of the first electrode plate 20.

The positive electrode non-coating portion 24 may be provided to facilitate the electrical connection during the manufacturing and assembly process of the electrode assembly 10, and the first electrode tab 62 connected to the positive electrode non-coating portion 24 may protrude toward an upper side of the first electrode plate 20.

The first electrode tab 62 may be used for external electrical connection during the winding or stacking process of the electrode assembly 10 and may also be welded or coupled to the electrode lead 110 extending to the outside of the case 80.

A size, position, and protrusion direction of the first electrode tab 62 may be adjusted according to the design specifications of the electrode assembly 10 and the structure of the case 80. For example, the first electrode tab 62 may be disposed at a center of the positive electrode non-coating portion 24 and may be provided to be exposed to the outside at the upper end of the wound electrode assembly 10.

In some embodiments, the first electrode tab 62 may be made of the same material (e.g., aluminum) as a metal base material layer of the first electrode plate 20 to improve current transmission efficiency and ensure connection reliability.

The first electrode plate 20 and the second electrode plate 30 may be folded and wound along the folding line 50 for each turn. The folding line 50 may serve as a folding reference point defined in the longitudinal direction y, along which the first electrode plate 20 and the second electrode plate 30 extend, and may induce the folding during the winding process to maintain the symmetry and precision of the electrode assembly 10.

The folding line 50 may be perpendicular to the direction, in which the first electrode plate 20, the second electrode plate 30, and the separator 40 are folded, and may optimize the space inside the wound electrode assembly 10. In some embodiments, the folding line 50 may include a first line 52 and a second line 54.

The first line 52 may be disposed at a center of the notching pattern and may be defined as a vertical line passing through the center of the first pattern 26. In some embodiments, the first line 52 may be provided in the same number as the number of first patterns 26 and may pass through the center of the first pattern 26 to extend in the longitudinal direction y. The first line 52 may stably induce foldings of the first electrode plate 20 and the second electrode plate 30 and may ensure folding regularity of the wound electrode assembly 10.

The second line 54 may be disposed in the middle between the first line 52 and an adjacent first line 52 and may be defined as a vertical line passing through the center of the positive electrode coating portion 22 or the negative electrode coating portion 32, on which the first pattern 26 is not disposed. The second line 54 may induce a folding on an area on which there is no first pattern 26 and may improve balance and internal density of the wound electrode assembly 10. Because the folding may be performed based on the non-notched area of the positive electrode coating portion 22 and the negative electrode coating portion 32, thereby improving the precision of the winding structure.

After the first electrode plate 20, the separator 40, the second electrode plate 30, and the separator 40 are sequentially stacked, a winding operation of the electrode assembly 10 may be performed in a state in which the first pattern 26 and a second pattern 36 face each other.

The first electrode plate 20 may be folded at the first line 52 and then be folded at the second line 54 centered on the positive electrode coating portion 22, and this operation may be repeated to complete the winding of the electrode assembly 10. The repetitive folding operation may optimize the internal structure of the wound electrode assembly 10 to improve the space utilization and the energy density.

The second electrode plate 30 may be wound together with the first electrode plate 20, and various modifications may be possible within the technical concept in which the predefined notching pattern is provided for each turn. The second electrode plate 30 may include a negative electrode coating portion 32 and a negative electrode non-coating portion 34, and a first pattern 36 may be disposed as a notching pattern on the areas.

The second electrode plate 30 may be provided in a square structure extending in the width direction x and may be designed to facilitate the winding and electrical connection of the electrode assembly 10. The negative electrode coating portion 32 and the negative electrode non-coating portion 34 may be configured to minimize an interference between the electrodes and prevent the electrical short-circuit during the winding process.

The second electrode plate 30 may be a plate-shaped plate made of copper (Cu) or nickel (Ni), and may include the negative electrode coating portion 32 coated with a graphite or carbon-based negative electrode active material on at least one surface. The negative electrode coating portion 32 may be a main area, on which reversible insertion and removal reactions of lithium ions occur, and may generate power through electrochemical reaction.

Natural graphite, artificial graphite, or amorphous carbon may be used as the negative electrode active material, and an additive such as silicon, a tin-based material, etc., may be contained as necessary.

The negative electrode non-coating portion 34 adjacent to the negative electrode coating portion 32 may be an area that is not coated with the negative electrode active material and may be mainly used for the electrical connection with the electrode tab 60. The negative electrode non-coating portion 34 may be designed to prevent an interference with the negative electrode coating portion 32 and to provide mechanical stability during the winding process. The negative electrode non-coating portion 34 may facilitate the electrical connection and contribute to preventing the electrical short-circuit during the manufacturing and assembly process of the electrode assembly 10.

The notching pattern disposed on the second electrode plate 30 may be provided as a second pattern 36 and may be disposed continuously at a set interval along the longitudinal direction y of the second electrode plate 30. The second pattern 36 may be generally designed in a square groove shape and may be transformed into a triangular, semicircular, or polygonal shape depending on the structural characteristics of the electrode assembly 10. The second pattern 36 may be disposed at any one of the lower end, the upper end, or the side surface of the negative electrode coating portion 32 and may contribute to maintain the balance within the wound electrode assembly 10 and optimize the energy density.

The second pattern 36 may be designed to correspond to the shape of the electrode assembly 10 in which the winding is completed and may be essentially used mainly in the electrode assembly 10 having a curved, multi-stage, or asymmetrical shape.

If the wound electrode assembly 10 has the rectangular shape in outer appearance, the second pattern 36 may be unnecessary, and in some embodiments, the symmetrical structure and the gap uniformity may be maintained without a separate notching pattern.

In the case of the asymmetric or curved electrode assembly 10, the second pattern 36 may be necessary to correct the internal curvature of the electrode assembly 10 and maintain the structural stability.

For example, if the wound electrode assembly 10 has a “U” shape, an “L” shape, or a multi-stage shape, the second pattern 36 may be designed to precisely control the folding and winding process of the electrode assembly 10. The gap between a plurality of second patterns 36 may be optimized by considering a radius, length, width, and winding radius of the electrode assembly 10.

The second electrode tab 64 may be electrically connected to the negative electrode non-coating portion 34 and may protrude to the outside of the case 80 for the external connection of the electrode assembly 10. A size, position, and protrusion direction of the second electrode tab 64 may be adjusted according to the design specifications and winding structure of the electrode assembly 10. For example, the second electrode tab 64 may be disposed at a center of the negative electrode portion 34 and may be exposed to the outside at the lower end of the wound electrode assembly 10.

The second electrode tab 64 may be made of the same material (e.g., copper) as the metal base material layer of the second electrode plate 30 to improve electrical connection reliability and current transmission efficiency.

The separator 40 may be disposed between the first electrode plate 20 and the second electrode plate 30 to electrically insulate the first electrode plate 20 from the second electrode plate 30, and to provide a movement path for lithium ions.

The separator 40 may be made of polyethylene (PE), polypropylene (PP), or a combination thereof, but the present disclosure is not limited to a specific material.

The separator 40 may prevent the electrical short while also acting as a medium that allows lithium ions to move freely between the positive and negative electrodes.

The separator 40 may be provided in a rectangular shape and may be wound together with the first electrode plate 20 and the second electrode plate 30 to constitute the electrode assembly 10.

In some embodiments, the separator 40 may be provided in a rectangular shape, and after being wound together with the first electrode plate 20 and the second electrode plate 30, only a portion corresponding to the notching pattern disposed on the first electrode plate 20 and the second electrode plate 30 may be cut.

In some embodiments, in a state in which the same pattern as that disposed on each of the first electrode plate 20 and the second electrode plate 30 is disposed in advance on the separator 40, the separator 40 may be wound to simplify the winding process and optimize the internal structure of the electrode assembly 10.

The separator 40 may be disposed across the entire first electrode plate 20 and second electrode plate 30 in the width direction x, and in some embodiments, a length of the separator 40 in the width direction x may be greater than that each of the first electrode plate 20 and the second electrode plate 30 in the width direction x.

In some embodiments, a length of the separator 40 in the longitudinal y may be greater than that of each of the first electrode plate 20 and the second electrode plate 30 in the longitudinal y.

In some embodiments, the separator 40 may have a width wider than or longer than that of each of the first electrode plate 20 and the second electrode plate 30 to prevent the interference of the electrodes during the winding process and provide more effectively the electrical insulation.

The separator 40 may prevent the electrical short circuit between the first electrode plate 20 and the second electrode plate 30 and may serve as a structural filter that only allows a movement of lithium ions.

This may ensure the stability of the electrochemical reaction and improve the operational reliability of the electrode assembly 10.

In some embodiments, the separator 40 may have a function of being melted at a certain temperature to block the electrical connection, thereby preventing a hazard that may occur in the event of overheating. For example, the separator 40 provided with the coating layer containing an inorganic material to enhance the thermal stability may be used.

The separator 40 may maintain a gap between the electrodes during the winding process while preventing the electrical short circuit. The position and size of the separator 40 within the wound electrode assembly 10 may play an important role in optimizing the electrical insulation effect.

The separator 40 may be disposed together with the electrode plate during the winding or stacking process of the electrode assembly 10 and may be utilized in various processes depending on the pattern formation and cutting method.

For example, if a pattern that is identical to the notching pattern disposed on each of the first electrode plate 20 and the second electrode plate 30 is provided in advance on the separator 40, and then, the winding process is performed, the manufacturing efficiency may be improved, and the pattern precision may be improved.

In some embodiments, the separator 40 may be changed to various sizes and shapes and thus may be applied to the electrode assembly 10 having not only the rectangular shape, but also the curved shape, multi-stage shape, or asymmetrical shape.

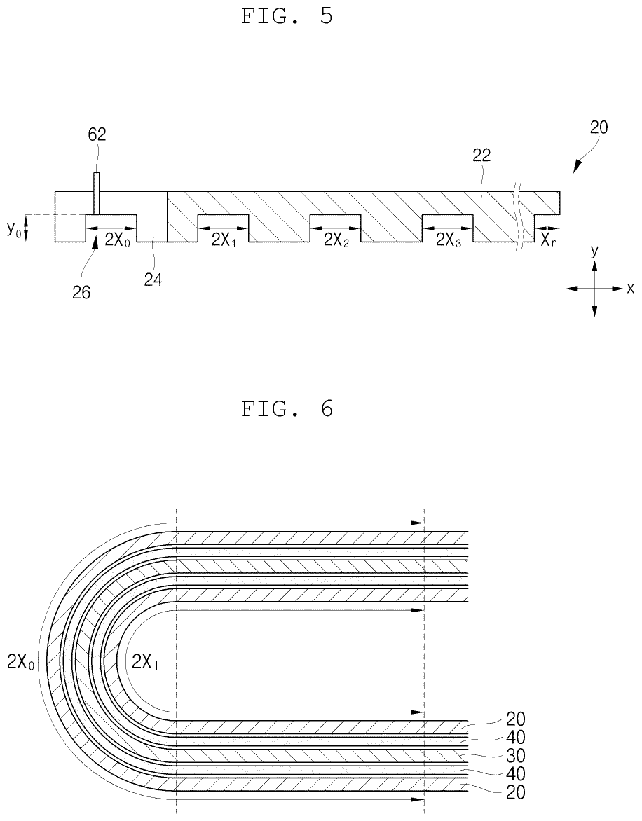

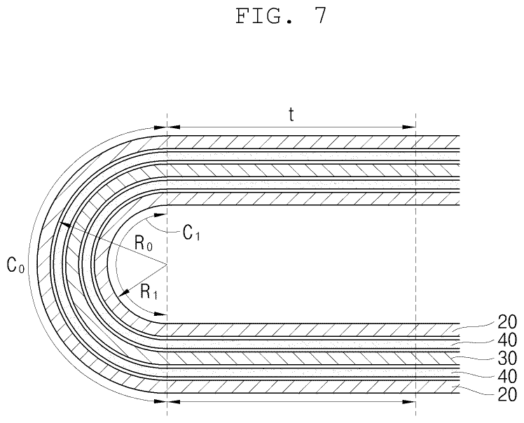

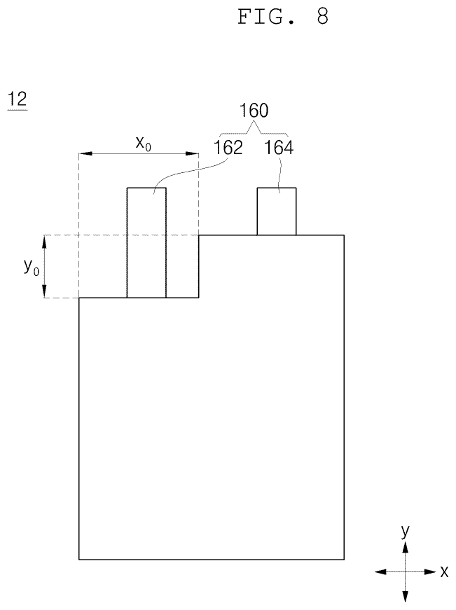

FIG. 5 illustrates a plan view of the positive electrode according to embodiments, FIG. 6 illustrates a cross-sectional view of one bent side of the electrode assembly according to embodiments, And FIG. 7 illustrates a cross-sectional view of a curvature and radius of the electrode assembly according to embodiments. As illustrated in FIGS. 5 and 6, a formula used for the length of the notching pattern in the width direction x will be described.

In some embodiments, the length of the notching pattern in the width direction is defined as 2xₙ=2(xₙ₊₁+f(aₐ₊₁)), where 2xₙ is a length of the notching pattern at an n-th turn in the width direction, 2xₙ₊₁ is a length of the notching pattern at an (n+1)-th turn in the width direction, and f(aₙ₊₁) represents a correction value calculated by considering the first electrode plate 20, the second electrode plate 30, the separator 40, and the spaced gap at the (n+1)-th turn.

The length of the notching pattern in the width direction will be described using the length of the first pattern 26 of the first electrode plate 20 in the width direction as an example. One side (left side in FIG. 5) of the first electrode plate 20 to which the first electrode tab 62 is connected may be disposed outside the electrode assembly 10 as a rear end. The other side (right side as illustrated in FIG. 5) of the first electrode plate 20 may be disposed at a center of the electrode assembly 10 as a front end.

Each of the plurality of first patterns 26 provided on the first electrode plate 20 may have a length that gradually decreases from the rear end to the front end. A length of the first pattern 26 in the longitudinal direction y may be the same as yₒ, and only the length of the first pattern 26 in the width direction x may be changed.

In some embodiments, a length of the second pattern 36 in the longitudinal direction y may be the same as yₒ, and only the length of the second pattern 36 in the width direction x may be changed. The length of each of the first pattern 26 and the second pattern 36 in the longitudinal direction y and a length of a stepped portion disposed on the outside of the electrode assembly 10 may be the same as yₒ.

The length of the first pattern 26 disposed on the positive electrode non-coating portion 24 in the width direction may be defined as 2xₒ, and the length of the first pattern 26 disposed on the positive electrode non-coating portion 22 in the width direction may be defined as 2x₁, 2x₂, and 2x₃ as it is directed toward the front end. In some embodiments, the length of the first pattern 26 disposed at the front end in the width direction may be defined as xₙ. The length of the first pattern 26 disposed at the front end in the width direction may be approximately half the length of another first pattern 26 in the width direction.

The length of the first pattern 26 in the width direction may be described as 2xₒ and 2x₁. As illustrated in FIG. 6, a shape in which the first electrode plate 20, in which the length of the first pattern 26 in the width direction is 2x₁, is disposed at the inside, and the first electrode plate 20, in which the length of the separator 40, the second electrode plate 30, the separator, and the first pattern 26 in the width direction is 2xₒ as it goes outward, are sequentially wound may be provided.

Because the length of the notching pattern in the width direction is defined as 2xₙ=2(xₙ₊₁+f(aₙ₊₁)), the length 2xₒ of the first pattern 26 in the width direction may be calculated as 2(x₁+f(a₁)).

As illustrated in FIG. 7, a radius of curvature of the first electrode plate 20, in which lengths of the first pattern 26 in the width direction is 2x₀ and 2x₁, may be R₀ and R₁.

If the length of the first pattern 26 in the width direction is 2x₀, a length of the curvature portion may be set to C₀. If the length of the first pattern 26 in the width direction is 2x₁, a length of the curvature portion may be set to C₁. If the length of the first pattern 26 in the width direction is 2x₀, a length in a straight direction may be set to 2t. If the length of the first pattern 26 in the width direction is 2x₁, a length in a straight direction may be set to 2t.

Thus, the following formula: 2x₀=2t+C₀ may be satisfied. The length of the first pattern 26 in the width direction may be set to C₀=πR₀ by the formula for finding the radius.

In the above-described manner, the length of another first pattern 26 in the width direction may be obtained.

If the length of the first pattern 26 in the width direction is 2x₁, the following formulas: 2x₁=2t+C₁, and C₁=πR₁ may be satisfied.

Therefore, the following equation may be derived.

$$2 {x}_{0} = 2 t + {C}_{0} = 2 {x}_{1} + 2 f ( {a}_{1} ) = 2 t + {C}_{1} + 2 f ( {a}_{1} )$$

$${C}_{0} - {C}_{1} = 2 f ( {a}_{1} )$$

$$f ( {a}_{1} ) = \frac{{C}_{0} - {C}_{1}}{2} = \frac{π ( {R}_{0} - {R}_{1} )}{2}$$

Therefore, the following calculation formula: f(aₙ)−π(Rₙ₋₁−Rₙ)/2 may be derived.

In some embodiments, the correction value f(aₙ) may be calculated as f(aₙ)−π(Rₙ₋₁−Rₙ)/2, where Rₙ is a winding radius defined with respect to the center of curvature disposed at the center of the notching pattern at the n-th turn, and Rₙ₋₁ is a winding radius defined with respect to the center of curvature disposed at the center of the notching pattern at the (n−1)-th turn.

In a state in which a groove of the first pattern 26 and a groove of the second pattern 36 communicate with each other, the first electrode plate 20 and the second electrode plate 30 may be wound to overlap each other with the separator 40 therebetween. The first electrode plate 20 and the second electrode plate 30 may be folded along the folding line 50 and wound while maintaining the uniform gap.

In some embodiments, the notching pattern of each of the first electrode plate 20 and the second electrode plate 30 may gradually decrease in pattern size as it goes toward the inside of the wound electrode assembly 10. This may contribute to correct an internal curvature of the wound electrode assembly 10 and disperse internal stress that may occur during the winding process.

In some embodiments, if the electrode assembly 10 has an asymmetrical shape or a curved outline, a size and gap of the notching pattern may be adjusted according to the winding direction and curvature.

The separator 40 may be disposed in harmony with the first electrode plate 20 and the second electrode plate 30 during the winding process to prevent a wrinkling phenomenon of the separator 40 therein and ensure electrical insulation performance.

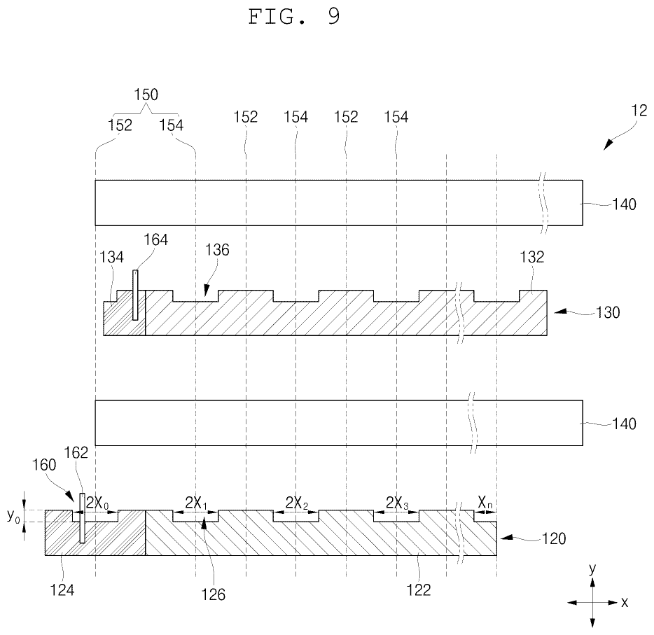

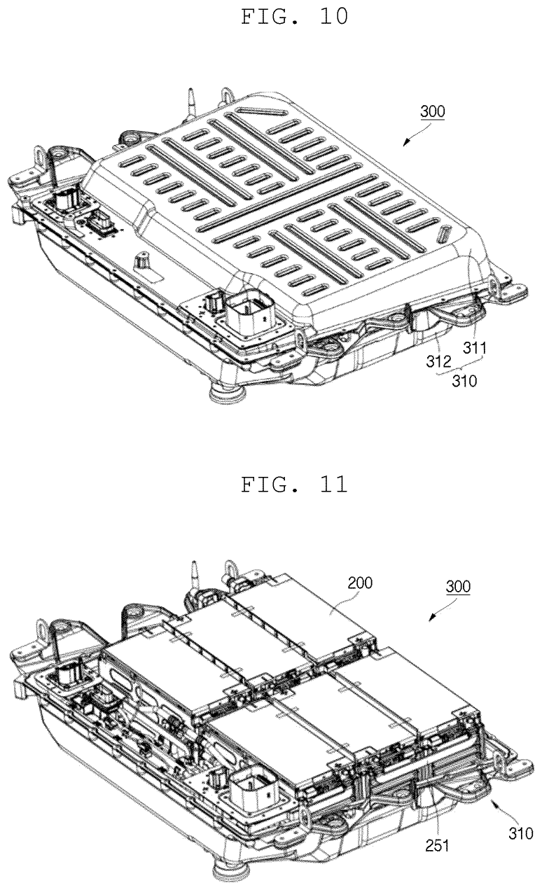

FIG. 8 illustrates a plan view of a secondary battery 1 according to other embodiments, and FIG. 9 illustrates an exploded plan view of an electrode assembly 12 according to other embodiments. As illustrated in FIGS. 8 and 9, the electrode assembly 12 according to other embodiments may include a first electrode plate 120, a second electrode plate 130, a separator 140, and an electrode tab 160. The electrode assembly 12 according to other embodiments may have a structure having an upper side provided in a multi-stage shape, and a height of one side of the wound electrode assembly 12 in a width direction x may be designed to be lower than a height of the other side. In some embodiments, a first pattern 126 and a second pattern 136 may be disposed at the upper side, unlike the foregoing embodiments of the present disclosure.

In some embodiments, the first pattern 126 and the second pattern 136 may be provided so that a length in the width direction x gradually decreases from a rear end to a front end of the electrode assembly 12. This design may relieve internal stress that may occur during a winding process of the electrode assembly 12 and improve space efficiency of the wound electrode assembly 12.

The first electrode plate 120 may include a positive electrode coating portion 122 and a positive electrode non-coating portion 124. The positive electrode coating portion 122 may be an are coated with a positive electrode active material and may be a main portion that generates power through an electrochemical reaction. The positive electrode non-coating portion 124 may be an area that is not coated with the positive electrode active material and may be used for electrical connection. A first pattern 126 may be disposed at an upper side of the first electrode plate 120, and the first pattern 126 may be provided in a square groove shape.

The second electrode plate 130 may include a negative electrode coating portion 132 and a negative electrode non-coating portion 134. The negative electrode coating portion 132 may be an area coated with a negative electrode active material and may be a portion involved in the electrochemical reaction. The negative electrode non-coating portion 134 may be an area that is not coated with the negative electrode active material and may be used for the electrical connection. A second pattern 136 may be disposed at an upper side of the second electrode plate 130, and the second pattern 136 may be provided in a square groove shape.

A separator 140 may be disposed between the first electrode plate 120 and the second electrode plate 130 to provide electrical insulation and may play a role in preventing an interference between the electrodes and improving structural stability during the winding process of the first electrode plate 120 and the second electrode plate 130.

The electrode tab 160 may include a first electrode tab 162 and a second electrode tab 164. The first electrode tab 162 may be electrically connected to the positive electrode non-coating portion 124 of the first electrode plate 120 and may protrude upward from the wound electrode assembly 12. The second electrode tab 164 may be electrically connected to the negative electrode portion 134 of the second electrode plate 130 and may protrude upward.

Other embodiments of the present disclosure may have a configuration that is the same as or similar to that according to the foregoing embodiments of the present disclosure, except that the first pattern 126 and the second pattern 136 are disposed at the upper side of the electrode assembly 12, and the multi-stage shape is provided at the upper side.

In other embodiments of the present disclosure, a folding line 150 may represent a folding reference line of the first electrode plate 120 and the second electrode plate 130 and may be designed to maintain symmetry and uniformity of the electrode assembly 12 during the winding process. The folding line 150 may be constituted by a first line 152 and a second line 154. Because the folding line 150 is the same as that according to the foregoing embodiments of the present disclosure, a detailed description of the folding line 150 will be omitted.

The electrode assembly 10,12 (see FIGS. 1, 3, 4, 8, and 9) according to the present disclosure will be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f})Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

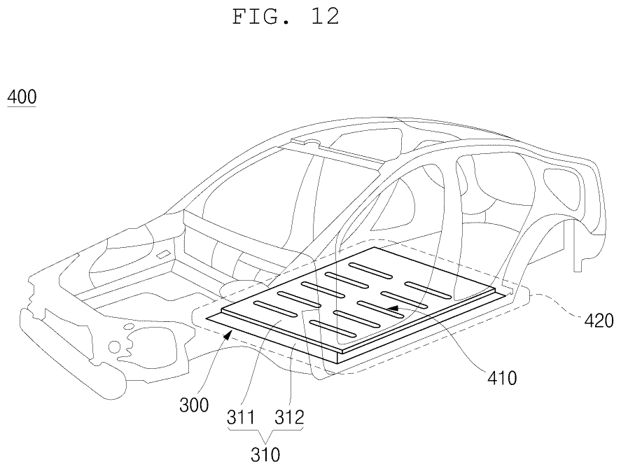

The batteries according to the above-described embodiments may be used to manufacture a battery pack. FIGS. 10 and 11 are perspective views showing a battery pack including the exemplary secondary battery according to the present disclosure. Referring to FIGS. 10 and 11, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

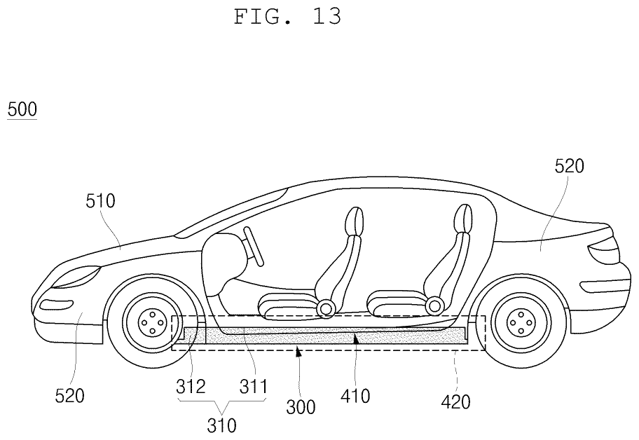

FIGS. 12 and 13 are, respectively, a perspective view and a side view showing vehicles 400 and 500 including the exemplary battery pack 300 according to the present disclosure.

In FIG. 12, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 13, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

According to the present disclosure, the symmetrical pattern notched in advance may be applied while implementing the winding-type two-dimensional cell to maintain the symmetry and the gap uniformity of the electrode assembly.

In some embodiments, the notching pattern may be designed in consideration of the thickness of the electrode plate, the gap between the electrode plates, and the difference in circumference at the ends before the winding (turning) to optimize the internal structure of the wound electrode assembly, thereby minimizing the dead space and improving the energy density (ED).

In some embodiments, the length difference that occurs for each turn may be corrected to improve the precision of the winding structure and reduce the folding and deformation phenomena, thereby enhancing the reliability and electrical stability of the secondary battery.

However, the effects achievable through the present invention are not limited to those described above, and other technical effects not mentioned can be clearly understood by those skilled in the art from the description of the invention provided above.

Although a few embodiments of the present disclosure have been shown and described, it would be appreciated by those skilled in the art that various changes and modifications may be made in this embodiment without departing from the principles and spirit of the disclosure.

What is claimed is:

1. A secondary battery comprising:
a first electrode plate on which a notching pattern is disposed for each turn of a winding process;
a second electrode plate that is wound with the first electrode plate and on which a notching pattern is disposed for each turn; and
a separator disposed between the first electrode plate and the second electrode plate the separator being configured to electrically insulate the first electrode plate and the second electrode plate from each other,
wherein each of the first electrode plate and the second electrode plate is folded and wound along a folding line for each turn.

2. The secondary battery as claimed in claim 1, wherein an electrode tab is connected to an end of the first electrode plate in a longitudinal direction.

3. The secondary battery as claimed in claim 1, wherein an electrode tab is connected to an end of the second electrode plate in a longitudinal direction.

4. The secondary battery as claimed in claim 1, wherein the first electrode plate is a positive electrode plate, and the second electrode plate is a negative electrode plate.

5. The secondary battery as claimed in claim 1, wherein the separator is a rectangular shaped, and
wherein, after being wound together with the first electrode plate and the second electrode plate, only a portion corresponding to the notching pattern disposed on each of the first electrode plate and the second electrode plate is cut.

6. The secondary battery as claimed in claim 1, wherein the separator is disposed across an entirety of the first electrode plate and the second electrode plate in a width direction, and
wherein a width of the separator is greater than a width of each of the first electrode plate and the second electrode plate.

7. The secondary battery as claimed in claim 1, wherein the notching pattern disposed on the first electrode plate is formed disposed along a longitudinal direction of the first electrode plate.

8. The secondary battery as claimed in claim 7, wherein the notching pattern comprises a square groove.

9. The secondary battery as claimed in claim 7, wherein the notching pattern disposed on the first electrode is a first pattern,
wherein the notching pattern disposed on the second electrode plate is a second pattern, and
wherein the second pattern is continuously disposed along a longitudinal direction of the second electrode plate.

10. The secondary battery as claimed in claim 9, wherein the second pattern comprises a square groove.

11. The secondary battery as claimed in claim 9, wherein, in a state in which the first electrode plate and the second electrode plate overlap each other with the separator therebetween while a groove of the first pattern and a groove of the second pattern correspond to each other, the first electrode plate and the second electrode plate are folded and wound.

12. The secondary battery as claimed in claim 1, wherein the notching patterns of the first electrode plate and the second electrode plate are different from each other for each turn of the winding, and
wherein pattern sizes gradually decrease as each of the notching patterns traverses a length towards an inside of the wound first and second electrode plates.

13. The secondary battery as claimed in claim 1, wherein the folding line is defined as a folding reference point along a longitudinal direction of each of the first electrode plate and the second electrode plate and is configured to induce a folding during a winding process of the first electrode plate and the second electrode plate.

14. The secondary battery as claimed in claim 13, wherein the folding line comprises:
a first line disposed at a center of the notching pattern; and
a second line disposed in a middle between the first line and an adjacent first line.

15. The secondary battery as claimed in claim 1, wherein a length of the notching pattern in the width direction is defined as 2xₙ=2(xₙ₊₁+f(aₙ₊₁)),
where 2xₙ is a length of the notching pattern at an n-th turn in the width direction,
2xₙ₊₁ is a length of the notching pattern at an (n+1)-th turn in the width direction, and
f(aₙ₊₁) represents a correction value calculated by considering the first electrode plate, the second electrode plate, the separator, and a spaced gap at an (n+1)-th turn.

16. The secondary battery as claimed in claim 15, wherein the correction value f(aₙ) is calculated as f(aₙ)=π(Rₙ₋₁−Rₙ)/2,
where Rₙ is a winding radius defined with respect to a center of curvature disposed at a center of the notching pattern at the n-th turn, and
Rₙ₋₁ is a winding radius defined with respect to a center of curvature disposed at a center of the notching pattern at an (n−1)-th turn.

17. A secondary battery comprising:
a case;
an electrode assembly accommodated in the case, the electrode assembly including:
a first electrode plate on which a notching pattern is disposed for each turn of winding;
a first electrode tab disposed at one side of an end of the first electrode plate in a longitudinal direction;
a second electrode plate that is wound together with the first electrode plate and on which a notching pattern is disposed for each turn;
a second electrode tab disposed at one side of an end of the second electrode plate in a longitudinal direction;
a separator disposed between the first electrode plate and the second electrode plate, the separator being configured to electrically insulate the first electrode plate and the second electrode plate from each other; and
wherein the first electrode plate, the second electrode plate, and the separator are wound,
wherein each of the first electrode plate and the second electrode plate is folded and wound along a folding line for each turn.

18. The secondary battery as claimed in claim 17, wherein the notching pattern disposed on the first electrode plate is continuously disposed along a longitudinal direction of the first electrode plate.

19. The secondary battery as claimed in claim 18, wherein the notching pattern disposed on the first electrode plate is a first pattern,
wherein the notching pattern disposed on the second electrode plate is a second pattern, and
wherein the second pattern is continuously disposed along a longitudinal direction of the second electrode plate.

20. The secondary battery as claimed in claim 19, wherein each of the first pattern and the second pattern comprises a square groove.
